(19) United States
(12) Patent Application Publication
(10) Pub. No.: US 2007/0201542 A1
(43) Pub. Date: Aug. 30, 2007

(54) Circuit Arrangement For Suppressing Interfering Signals In Transmitted Signals Emitted By A Modem Of A Household Appliance

(75) Inventors: Udo Hertel, Regensburg (DE); Simon Piermeier, Regensburg (DE)

Correspondence Address: LERNER GREENBERG STEMER LLP, P O BOX 2480, HOLLYWOOD, FL, 33022-2480, US

(73) Assignee: BSH Bosch und Siemins Hausgerate GmbH, Munchen (DE)

(21) Appl. No.: 11/632,508

(22) PCT Filed: Jul. 12, 2005
(86) PCT No.: PCT/EP05/53323

§ 371 Date: Apr. 11, 2007

(30) Foreign Application Priority Data
Jul. 15, 2004 (DE) 10 2004 034 328.4

(51) Int. Cl. H04L 5/16

(52) U.S. Cl. 375/222

(57) ABSTRACT

A circuit arrangement for suppressing interfering signals in transmitted signals emitted by a modem of a household appliance equipped with a transmitting device for transmitting and a receiving device for receiving data signals, the modem containing a transmitting branch and a receiving branch. A low-pass filter for attenuating the interfering signals, which have interfering signal frequencies higher than the transmitted signal frequencies and which are emitted by a transmitter unit of the modem, is contained in the transmitting branch of the modem. In addition, a band elimination filter that filters out only the aforementioned interfering signals is connected upstream from the low-pass filter on the side of the transmitter unit.

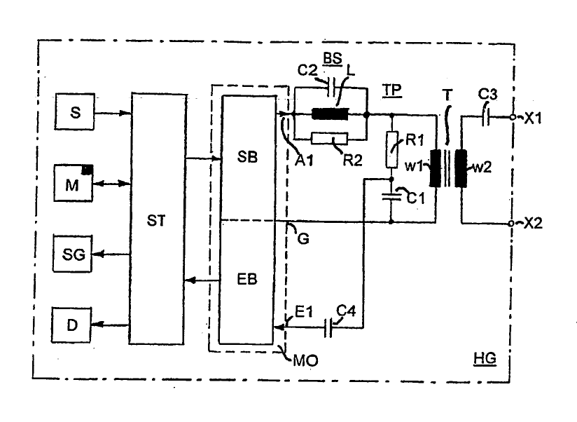

The invention relates to a circuit arrangement for suppressing interfering signals in transmitted signals emitted by a modem of a household appliance equipped with a transmitting device for transmitting and a receiving device for receiving data signals, said modem containing a transmitting branch and a receiving branch, and the transmitting branch of said modem containing a low-pass filter for attenuating the interfering signals which are emitted by a transmitter unit of the modem and which have interfering signal frequencies higher than the transmitted signal frequencies.

In a known circuit arrangement for transmitting data signals from and/or to household appliances (D1: U.S. Pat. No. 6,590,493 B1), in each case one band of individual household appliances is connected to a mains AC voltage line arrangement via a separate filter arrangement. The filter arrangements of different groups of household appliances are dimensioned so that the data signals transmitted in one group of household appliances cannot reach the household appliances belonging to a different group of household appliances. LC low-pass filters having different configurations are used for the relevant filter arrangements. In this connection, no further details are known about measures for the selective elimination of interfering signals which are induced in the respective household appliance and which lie above the transmitted signal frequencies.

In another known circuit arrangement of the type specified initially (D2: U.S. Pat. No. 6,396,392 B1), the respective transmitting/receiving device comprises a modem connected to the respective household appliance which is connected to the mains AC circuit arrangement by means of a coupler. Various filters such as low-pass filters and band-pass filters are contained in the modem and in the coupler. In this connection also, no further details are known about measures for the selective elimination of interfering signals which are induced in the respective household appliance and which lie above the transmitted signal frequencies.

Interfering signals such as those which have been mentioned previously and which are higher than the respective transmitted signal frequencies, can sometimes occur at amplitudes which cannot be sufficiently suppressed by simple LC low-pass filters and optionally band-pass filters. The reason for this is primarily the relatively flat filter characteristic profile. If filters with steeper filter edges were used, interfering signals of the afore-mentioned type can be effectively suppressed; however, the expenditure on circuitry required to achieve such filters would be disproportionately high.

An active low-pass filter with a frequency-dependent passive network and an amplifier is now known (D3: DE 27 40 244 C2). In this active low-pass filter, an additional capacitor is inserted in the path between the passive band elimination filter and the reference potential in a Hall-type active band elimination filter having a small filter slope. In this case, a passive low-pass filter is located before the passive band elimination filter in a manner known per se. This known filter arrangement can be used to produce an active low-pass filter with a very steep slope with low ripple and high stop band attenuation. The relevant known filter arrangement can produce a relatively accurate filter profile with relatively inaccurate standard components. However, the associated circuitry expenditure is considered to be too high in some cases.

It is therefore the object of the present invention to further develop a circuit arrangement of the type specified initially in such a manner that an interfering signal of known frequency or frequencies which appears in the respective transmitted signal and which cannot be sufficiently attenuated using the available low-pass filter can be effectively eliminated with relatively low expenditure on circuitry.

The object indicated hereinbefore is achieved in a circuit arrangement of the type specified initially according to the invention whereby a band elimination filter which filters out said interfering signals is connected upstream of said low-pass filter on the side of the relevant transmitter unit.

The invention has the advantage that it manages with a band elimination filter which is relatively simple to implement and which is connected upstream of said low-pass filter and therefore with relatively low expenditure on circuitry in order to achieve the desired elimination of interfering signals. No amplifier such as is required in the known active low-pass filter considered previously is used here.

The low-pass filter is advantageously simply formed by an LC filter arrangement with at least one inductance and one capacitor. Optionally, the relevant LC filter arrangement also contains an ohmic resistance for specifying a specific filter characteristic profile.

The band elimination filter is appropriately formed at least by said inductance of the LC filter arrangement and a capacitor connected in parallel with this inductance. This results in a particularly low expenditure on circuitry with regard to the implementation of said band elimination filter. Said parallel circuit also optionally contains an ohmic resistance whereby a simple filter characteristic profile of said band elimination filter can be simply achieved.

An exemplary embodiment of the circuit arrangement according to the present invention is explained in detail with reference to a drawing.

The drawing shows schematically a household appliance HG equipped with a circuit arrangement for suppressing interfering signals in transmitted signals emitted by a modem MO of a household appliance HG equipped with a transmitting device for emitting data signals and a receiving device for receiving data signals, said modem containing a transmitting branch and a receiving branch. The relevant household appliance HG can be any networkable household appliance such as a washing machine, a drier, a cooker, a refrigerator, a heating system etc. A networkable household appliance is understood here as any household appliance which can be connected by means of a transmitting and/or receiving device to a communication network for transmitting various data signals. In the present case, this communication network comprises the mains AC voltage network from which the supply voltages required for operation of the respective household appliances are taken. However, it is naturally also possible to use any other network such as the internet as the communication network.

The circuit arrangement shown in the drawing contains a modem containing a transmitting branch and a receiving branch which in the present case is shown as containing a transmitting unit SB and a receiving unit EB. These units SB and EB can comprise a combined commercial transmitting/receiving unit (for example, D4: AN 1714 mains FSK transmitting/receiving unit from STMicroelectronics—see publication of this firm dated June 2003).

Connected to the afore-mentioned modem MO is a control device ST, which in this case belongs to a transmitting device and a receiving device of the circuit arrangement. In the present case, in addition to the control device ST, the transmitting device of the relevant circuit arrangement comprises one or more sensors S provided in the household appliance, for example, to detect one or more parameters of state of the household appliance HG and a memory M in which data signals can be stored in the form of status signals and/or working programs of the relevant household appliance HG. In addition to the control device ST, the receiving device of the relevant circuit arrangement comprises, for example, one or more control elements SG, a display device D, such as an LCD display device, for example, and the previously mentioned memory S. Data signals can be sent to the relevant control elements SG in the afore-mentioned receiving branch; data signals transmitted in the receiving branch can also be stored in the afore-mentioned memory M and displayed in the display device D. The data signals transmitted in the receiving branch can, for example, comprise test signals in the course of carrying out remote diagnoses or new working programs or parts thereof for updating the working programs of the household appliance HG stored in the afore-mentioned memory M.

A low-pass filter for attenuating signal frequencies higher than the transmitted signal frequencies is connected between a signal output connection A1 of the transmitting unit SB and a reference potential connection G, which carries earth potential for example, and which is provided jointly for the transmitting unit SB and the receiving unit EB. In the present case, this low-pass filter TP merely comprises an inductance L located in the transmitting branch of the transmitting unit SB, preferably in the form of a coil, as well as the series circuit comprising a capacitor C1 and an ohmic resistance R1. Located in parallel to the series circuit consisting of the capacitor C1 and the ohmic resistance R1 is a winding w1 of a matching transformer T provided for electrical isolation, which is connected to a further winding w2 and a capacitor C3 located in series thereto at connections X1, X2 of the circuit arrangement shown. The two windings w1 and w2 of the matching transformer T can have a winding ratio of 1:1. The afore-mentioned communication network will be or is connected to the connections X1, X2.

In the present case, the receiving branch of the receiving unit EB is connected via the capacitor C4 to the connection point between the capacitor C1 and the ohmic resistance R1. This capacitor C4 is connected to the signal input connection E1 of the receiving unit EB at the pin assigned to the afore-mentioned connection point.

In addition to the low-pass filter TP considered previously, the circuit arrangement shown in the drawing also has a band elimination filter BS which is connected upstream of the low-pass filter TP on the side of the relevant transmitting unit SB. In the present case, the band elimination filter BS consists of the afore-mentioned inductance L and a capacitor C2 connected in parallel thereto and optionally an ohmic resistance R2 which in the present case is also connected in parallel to the inductance L. Thus, the inductance L is used both for the low-pass filter TP and also for the band elimination filter BS which represents a particularly low expenditure on circuitry with regard to the implementation of the filter.

The low-pass filter TP is dimensioned so that signal frequencies higher than the transmitted signal frequency are attenuated significantly in the transmitting branch under study. The transmitted signal frequencies are located, for example, at 132.5 kHz.

In order to suppress interfering signals reaching the output of the circuit arrangement according to the invention, which are higher than the transmitted signal frequencies and which are generated by the transmitting unit SB despite using the low-pass filter TP, the band elimination filter BS in the present case is dimensioned in such a manner that it precisely filters out these interfering signals. Such interfering signals can occur, for example, at 1.2 MHz and 1.46 MHz., that is significantly higher than the transmitted signal frequencies and can have amplitudes such that the low-pass filter TP alone cannot sufficiently attenuate them. Only the combined use of the low-pass filter TP and the band elimination filter BS can keep the transmission path and therefore the communication network to which the circuit arrangement according to the invention is connected for data signal transmission, free from interfering signals higher than the transmitted signal frequencies, and overall with a particularly low expenditure on circuitry.

### REFERENCE LIST

A1 Signal output connection
BS Band elimination filter
C1 Capacitor
C2 Capacitor
C3 Capacitor
C4 Capacitor
D Display device
E1 Signal input connection
EB Receiving unit
G Reference potential connection
HG Household appliance
L Inductance
M Memory
MO Modem
R1 Ohmic resistor
R2 Ohmic resistor
S Sensors
SB Transmitting unit
SG Control elements
ST Control device
T Matching transformer
TP Low-pass filter
w1 Winding
w2 Winding
X1 Connection
X2 Connection

1-5. (canceled)

6. A circuit arrangement for suppressing interfering signals in transmitted signals emitted by a modem of a household appliance equipped with a transmitting device for transmitting and a receiving device for receiving data signals, the modem containing a transmitting branch and a receiving branch, the circuit which comprises:
a low-pass filter in the transmitting branch of the modem for attenuating interfering signals emitted by a transmitter unit of the modem and having interfering signal frequencies higher than transmitted signal frequencies;
a band elimination filter connected between said low-pass filter and said transmitter unit, said band elimination filter, in combination with said low-pass filter, filtering out the interfering signals of the transmitter unit having such amplitudes that cannot be sufficiently attenuated by said low-pass filter alone.

7. The circuit arrangement according to claim 6, wherein said low-pass filter is an LC filter comprising at least one inductance and at least one capacitor.

8. The circuit arrangement according to claim 7, wherein said LC filter further comprises an ohmic resistance.

9. The circuit arrangement according to claim 7, wherein said band elimination filter comprises said inductance of said LC filter and a capacitor connected in parallel thereto.

10. The circuit arrangement according to claim 9, which further comprises an ohmic resistance connected in said parallel circuit.

11. In a household appliance equipped for transmitting and receiving data signals, a circuit comprising:
a modem having a transmitting branch with a transmitter unit for transmitting the data signals and a receiving branch for receiving the data signals;
a suppression circuit connected in said transmitting branch for suppressing interfering signals in transmitted signals emitted by said modem, said suppression circuit including:
a low-pass filter for attenuating interfering signals emitted by said transmitter unit and having interfering signal frequencies higher than transmitted signal frequencies; and
a band elimination filter connected between said low-pass filter and said transmitter unit, said band elimination filter together with said low-pass filter, filtering out the interfering signals of the transmitter unit having such amplitudes that cannot be sufficiently attenuated by said low-pass filter alone.
